(19) United States
(12) Patent Application Publication
(10) Pub. No.: US 2007/0097256 A1
(43) Pub. Date: May 3, 2007

(54) Receiver, transmitting/receiving system, and communication method

(75) Inventor: Atsushi Maehara, Osaka (JP)

Correspondence Address: NIXON & VANDERHYE, PC, 901 NORTH GLEBE ROAD, 11TH FLOOR, ARLINGTON, VA, 22203, US

(73) Assignee: SHARP KABUSHIKI KAISHA, Osaka (JP)

(21) Appl. No.: 11/588,390

(22) Filed: Oct. 27, 2006

(30) Foreign Application Priority Data
Oct. 27, 2005 (JP) 2005-312511

(51) Int. Cl. H04N 11/02

(52) U.S. Cl. 348/387.1

(57) ABSTRACT

The amount of data stored in a buffer 15 included in a transmitter 2 is detected by a buffer amount detecting section 18 with predetermined timing, and according to the amount of data stored in the buffer, the time intervals at which the data is fed out are adjusted based on a clock signal inputted from a clock generating section 14. If the amount of data is more than a predetermined upper limit value, the time intervals at which the data is fed out are shortened by a predetermined number of clocks; if it is less than a predetermined lower limit value, the time intervals at which the data is fed out are lengthened by a predetermined number of clocks. Thus, the amount of data stored in the buffer can be kept within a predetermined range.

This nonprovisional application claims priority under 35 U.S.C. § 119(a) on patent application Ser. No. 2005-312511 filed in Japan on Oct. 27, 2005, the entire contents of which are hereby incorporated by reference.

### BACKGROUND OF THE INVENTION

1. Field of the Invention

The present invention relates to a transmitting/receiving system in which video or audio data inputted from a content source is transmitted by a transmitter and the thus transmitted data is received by a receiver and then outputted from an output unit such as a monitor.

2. Description of Related Art

FIG. 5 is a block diagram showing a conventional transmitting/receiving system in which a transmitter transmits video data to a receiver. The transmitting/receiving system 900 is composed of a receiver 901, a transmitter 902, a video-outputting section 911 connected to the receiver 901, and a content source 921 connected to the transmitter 902.

The transmitter 902 is provided with: an external IF 922 that is externally connected to receive data; a stream data generating section 923 that generates stream data from video or audio data inputted via the external IF 922; a buffer 925 that temporarily stores the stream data generated in the steam data generating section 923; a communication data generating section 926 that generates from the stream data stored in the buffer 925 communication data in a form in which it is transmitted to the receiver 901; a communication section 927 that transmits to the receiver 901 the communication data generated in the communication data generating section 926; and a clock generating section 924 that generates and then feeds a clock signal to the stream data generating section 923 to control the speed at which the stream data generating section 923 generates the stream data.

On the other hand, the receiver 901 is provided with: a communication section 917 that receives the communication data transmitted from the transmitter 902; a stream data acquiring section 916 that acquires the stream data from the communication data received in the communication section 917; a buffer 915 that temporarily stores the stream data acquired in the stream data acquiring section 916; a data reconstructing section 913 that reconstructs from the stream data stored in the buffer 915 the video or audio data; an external IF 912 that serves as an externally connected interface so as to output the video or audio data reconstructed by the data reconstructing section 913; and a clock generating section 914 that generates and then feeds a clock signal to the data reconstructing section 913 to control the speed at which the video or audio data is reconstructed from the stream data stored in the buffer 915.

In the transmitting/receiving system 900 configured as described above, the video or audio data stored in the content source 921 is first fed to the transmitter 902 via the external IF 922. The video or audio data received via the external IF 922 is fed to the stream data generating section 923, and is then converted into the stream data at a speed corresponding to the clock signal inputted from the clock generating section 924. The stream data thus generated is stored in the buffer 925. The stream data read from the buffer 925 is converted into transmittable communication data by the communication data generating section 926, and is then transmitted to the receiver 901 through the communication section 927.

The communication data transmitted from the transmitter 902 is received by the communication section 917 included in the receiver 901, and is then fed to the stream data acquiring section 916 in which the stream data included in the communication data is acquired. The acquired stream data is then stored in the buffer 915. The data reconstructing section 913 reconstructs the video or audio data from the stream data stored in the buffer 915 at a speed corresponding to the clock signal inputted from the clock generating section 914. The video or audio data reconstructed by the data reconstructing section 913 is fed to the video-outputting section 911 via the external IF 912 so that the user of the system can watch and listen to it.

Here, if the speed at which the transmitter 902 generates the stream data does not coincide with the speed at which the receiver 901 reconstructs the video or audio data from the stream data, the stream data stored in the buffer 915 exceeds its maximum storage capacity or runs out. Disadvantageously, this hampers the user of the system from smoothly watching or listening to the video or audio in real time.

### SUMMARY OF THE INVENTION

In view of the conventionally experienced disadvantages mentioned above, it is an object of the present invention to provide a transmitting/receiving system that can prevent running-out or overflowing of the data stored in a buffer included in a receiver, and to provide a receiver and a communication method for use in such a transmitting/receiving system.

To achieve the above object, according to the present invention, a receiver is provided with: a receiving section that receives communication data including stream data; a buffer for temporarily storing the stream data that is acquired from the communication data received in the receiving section; a data amount detecting section that detects the amount of data stored in the buffer; and a timing determining section that determines the timing with which the data stored in the buffer is read.

According to one aspect of the present invention, a transmitting/receiving system is provided with: the receiver described above; and a transmitter that generates the stream data including at least a piece of video or audio data and that then converts the stream data to the communication data in a transmittable form to transmit the communication data to the receiver.

According to another aspect of the present invention, a communication system is provided with: a first step of receiving the communication data including the stream data; a second step of temporarily storing in a buffer the stream data that is acquired from the communication data received in the first step; a third step of detecting the amount of data stored in the buffer; and a fourth step of determining the timing with which the data stored in the buffer is read according to the amount of data detected in the third step. Here, the receiver receives the stream data transmitted from the transmitter.

With a configuration according to the present invention, the amount of data stored in the buffer can be kept within a predetermined range through adjustment, according to the amount of data stored in the buffer, of the timing with which the data is read. This helps prevent running-out of the data stored in the buffer and overflowing of the data stored in the buffer beyond the capacity thereof.

### BRIEF DESCRIPTION OF THE DRAWINGS

FIG. 1 is a block diagram showing the configuration of a transmitting/receiving system according to the present invention;

FIG. 2 is a flowchart illustrating how the timing with which data is fed out is adjusted based on the detection result from a buffer amount detecting section 18;

FIG. 3 is a conceptual diagram illustrating how the time intervals at which data is fed out are adjusted;

FIG. 4 is a schematic block diagram showing the structure of the data stored in the buffer 15; and

FIG. 5 is a block diagram showing the configuration of a conventional transmitting/receiving system.

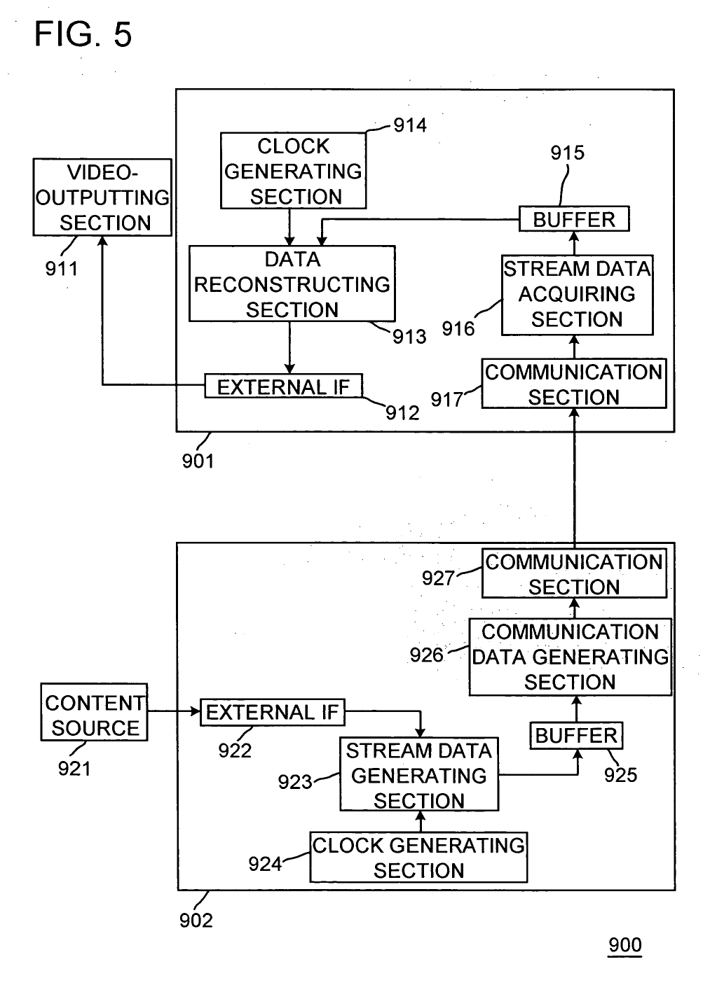

### DETAILED DESCRIPTION OF PREFERRED EMBODIMENTS

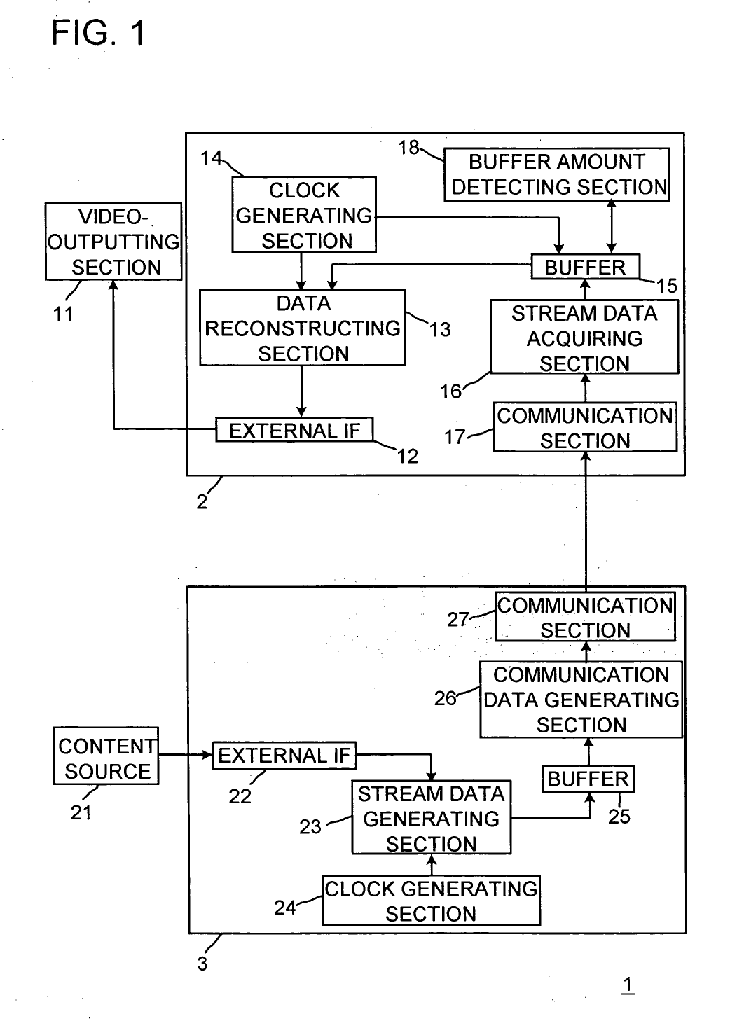

Hereinafter, an embodiment of the present invention will be described with reference to the accompanying drawings. FIG. 1 is a block diagram showing the configuration of a transmitting/receiving system embodying the present invention. The transmitting/receiving system I is composed of a receiver 2, a transmitter 3, a video-outputting section 11 connected to the receiver 2, and a content source 21 connected to the transmitter 3. The content source 21 may be any storage medium that can store video or audio or both data, for example a DVD player, HD recorder, or VCR.

The transmitter 3 is provided with: an external IF 22 that is externally connected to receive data; a stream data generating section 23 that generates stream data from video or audio data inputted via the external IF 22; a buffer 25 that temporarily stores the stream data generated in the steam data generating section 23; a communication data generating section 26 that generates from the stream data stored in the buffer 25 communication data in a form in which it is transmitted to the receiver; a communication section 27 that transmits to the receiver 2 the communication data generated in the communication data generating section 26; and a clock generating section 24 that generates and then feeds a clock signal to the stream data generating section 23 to control the speed at which the stream data generating section 23 generates the stream data.

On the other hand, the receiver 2 is provided with: a communication section 17 that receives the communication data. transmitted from the transmitter 3; a stream data acquiring section 16 that acquires the stream data from the communication data received in the communication section 17; a buffer 15 that temporarily stores the stream data acquired in the stream data acquiring section 16; a data reconstructing section 13 that reconstructs from the stream data stored in the buffer 15 the video or audio data; an external IF 12 that serves as an externally connected interface so as to output the video or audio data reconstructed by the data reconstructing section 13; a clock generating section 14 that generates and then feeds a clock signal to the data reconstructing section 13 to control the speed at which the video or audio data is reconstructed from the stream data stored in the buffer 15; and a buffer amount detecting section 18 that detects the amount of data stored in the buffer 15. Here, the clock signal outputted from the clock generating section 14 is fed to the buffer 15 so that, based on this clock signal, the timing with which the data stored in the buffer 15 is fed to the data reconstructing section 13 is controlled.

Now, the operation of the transmitting/receiving system I configured as described above will be described. The video or audio data stored in the content source 21 is first fed to the transmitter 3 via the external IF 22. The video or audio data is fed to the stream data generating section 23, and is then converted into digital stream data such as MPEG-2 at a speed corresponding to the clock signal inputted from the clock generating section 24. The stream data thus generated is stored in the buffer 25. The stream data read from the buffer 25 is converted into transmittable communication data by the communication data generating section 26. This communication data is then transmitted to the receiver 2 through the communication section 27.

The receiver 2 receives, in the communication section 17, the communication data transmitted from the transmitter 3, and then feeds it to the stream data acquiring section 16 to acquire the stream data included in the communication data. The acquired stream data is then stored in the buffer 15. The buffer 15 feeds the data stored therein to the data reconstructing section 13 with timing corresponding to the clock signal fed from the clock generating section 14. Here, as described above, the buffer amount detecting section 18 detects the amount of data stored in the buffer 15 so that, based on the detection result, the buffer 15 adjusts the timing with which the data is fed out. How this timing is adjusted will be described later.

More precisely, the buffer 15 may feed the data to the data reconstructing section 13 according to an instruction signal from a data feeding instruction section (unillustrated) that instructs the buffer 15 to feed out the data, and the data may be fed from the buffer 15 according to the timing determined by the data feeding instruction section based on the amount of data stored in the buffer 15 and the clock signal.

The data reconstructing section 13 reconstructs from the stream data stored in the buffer 15 the video or audio data at the speed corresponding to the clock signal inputted from the clock generating section 14. The video or audio data reconstructed by the data reconstructing section 13 is fed to the video-outputting section 11 via the external IF 12 so that the user of the system can watch and listen to it. A television set is one example of the video-outputting section 11.

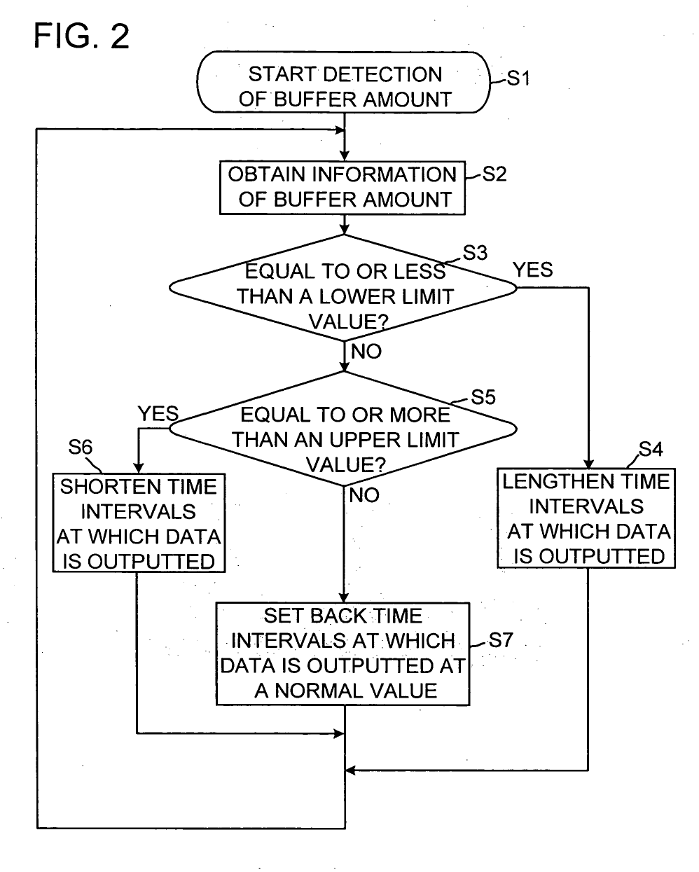

Next, how the timing with which the data stored in the buffer 15 is fed out is adjusted based on the detection result from the buffer amount detecting section 18 will be described. FIG. 2 is a flow chart illustrating how the timing with which the data is fed out is adjusted based on the detection result from the buffer amount detecting section 18.

When the transmitter 3 starts to feed the video or audio data to the receiver 2, the buffer amount detecting section 18 starts to detect the amount of data stored in the buffer 15 (step S1). The buffer amount detecting section 18 obtains information about the data stored in the buffer 15 at predetermined time intervals to know the amount of data stored in the buffer (step 2).

Based on the data information from the buffer amount detecting section 18, the buffer 15 varies the time intervals at which the data is outputted to the data reconstructing section 13. Specifically, whether or not the amount of data stored in the buffer is equal to or less than a lower limit value is checked (step S3), and, if it is equal to or less than the lower limit value (yes in step S3), then the time intervals at which the data is outputted are lengthened (step S4).

In contrast, if the amount of data stored in the buffer is equal to or more than the lower limit value (no in step S3), then whether or not it is equal to or more than an upper limit value is further checked (step S5). Here, if the amount of data stored in the buffer is equal to or more than the upper limit value (yes in step S5), then the time intervals at which the data is outputted are shortened, and, if the amount of data stored in the buffer is equal to or less than the upper limit value (no in step S5), then the time intervals at which the data is outputted are set back at a normal value (step S7).

As described above, the upper and lower limit values are set previously, and the time intervals at which the data is outputted are varied if the amount of data stored in the buffer is equal to or less than the lower limit value or if it is equal to or more than the upper limit value. This makes it possible to keep the amount of data stored in the buffer within a predetermined range.

When the speed at which the stream data is generated is slower than the speed at which the video or audio data is reconstructed from the stream data, the amount of data stored in the buffer 15 decreases. In this case, the amount of data stored in the buffer is compared with the predetermined lower limit value, and, if the amount of data stored in the buffer is found to be equal to or less than the lower limit value, then the time intervals at which the data is fed out is lengthened. This decreases the apparent data reconstruction speed.

In contrast, when the speed at which the stream data is generated is faster than the speed at which the video or audio data is reconstructed from the stream data, the amount of data stored in the buffer 15 increases. In this case, the amount of data stored in the buffer is compared with the predetermined upper limit value, and, if the amount of data stored in the buffer is found to be equal to or more than the upper limit value, then the time intervals at which the data is fed out is shortened. This increases the apparent data reconstruction speed.

Through the steps described above, the amount of data stored in the buffer 15 can be kept within the predetermined range between the lower and upper limit values. Keeping the amount of data stored in the buffer within the predetermined amount means that the generation of the stream data synchronizes with the reconstruction of the video or audio data from the stream data . Thus, it is possible to prevent running-out of the data stored in the buffer and overflowing of the data stored in the buffer beyond the capacity thereof.

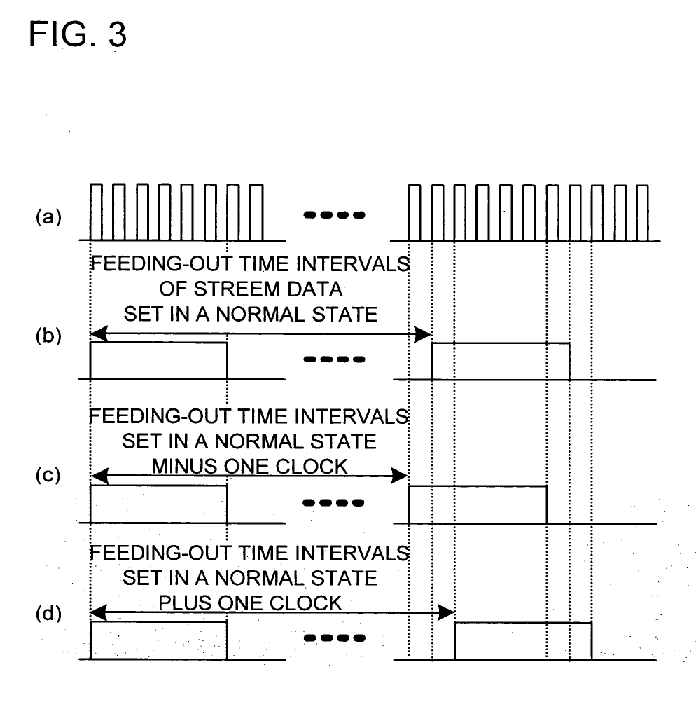

Next, how the time intervals at which the stream data is fed out from the buffer 15 are adjusted will be described. FIG. 3 is a conceptual diagram illustrating how the time intervals at which the data is fed out are adjusted.

FIG. 3 is a time chart showing, at (a), the clock signal outputted from the clock generating section 14 and, at (b) to (d), how data is fed from the buffer 15 to the data reconstructing section 13 in different states, among which is a normal state in which the data is fed out as shown at (b).

First, a description will be given of the normal state. The clock signal fed from the clock generating section 14 is first fed to the buffer 15. Based on the rise of the clock signal, the buffer 19 starts to feed out the data, and then, when a predetermined number of clock pulses are counted, the buffer 19 stops feeding out the data. Thereafter, when another predetermined number of clock pulses inputted from the clock generating section are counted, the buffer 19 starts to feed out the data again.

As described above, the time intervals at which the data is fed out from the buffer 15 to the data reconverting section are previously set so that, when the predetermined number of clock pulses are counted, the buffer 15 starts to feed out the predetermined amount of data. Here, the clock signal which the clock generating section 14 generates is assumed to have a constant frequency.

At this point, if the amount of data stored in the buffer 15 is found to be equal to or less than the lower limit value (yes in step S3), the speed at which the stream data is generated is recognized to be slower than the speed at which the video or audio data is reconstructed from the stream data. In response, the time intervals at which the stream data is fed out from the buffer are lengthened so as to decrease the apparent data reconstruction speed (step S4). Specifically, the time intervals at which the data is fed out are set at a value corresponding to a predetermined number of clock pulses greater than the number of clock pulses set for the normal state.

In the time chart of FIG. 3, at (d) is shown the state where the time intervals at which the data is fed out have been lengthened by one clock pulse with respect to the normal state shown at (b). In this way, based on the inputted clock signal, the timing with which the data is fed out is delayed with respect to the timing that would be chosen in the normal state. This helps reduce the difference between the speed at which the stream data is generated and the speed at which the video or audio data is reconstructed from the stream data. Thus, it is possible to prevent running-out of the data stored in the buffer.

In contrast, if the amount of data stored in the buffer 15 is found to be equal to or more than the upper limit value (yes in step 5), the speed at which the stream data is generated is recognized to be faster than the speed at which the video or audio data is reconstructed from the stream data. In response, the time intervals at which the stream data is fed out from the buffer are shortened so as to increase the apparent data reconstruction speed (step S6). Specifically, the time intervals at which the data is fed out are set at a value corresponding to a predetermined number of clock pulses less than the number of clock pulses set for the normal state.

In the time chart of FIG. 3, at (c) is shown the state where the time intervals at which the data is fed out have been shortened by one clock pulse with respect to the normal state shown at (b). In this way, based on the inputted clock signal, the timing with which the data is fed out is hastened with respect to the timing that would be chosen in the normal state. This helps reduce the difference between the speed at which the stream date is generated and the speed at which the video or audio data is reconstructed from the stream data. Thus, it is possible to prevent overflowing of the data in the buffer beyond the capacity thereof

In FIG. 3, the feeding-out time intervals are adjusted by one clock pulse. This, however, is not meant to limit the increment of adjustment to one clock pulse; instead, adjustments may be made in increments of periods corresponding to a predetermined number of clock pulses.

As described above, within the receiver 2, the time intervals at which the data is fed out from the buffer 5 are adjusted by use of the clock signal. Thus, it is possible to prevent running-out of the data stored in the buffer and overflowing of the data beyond the capacity thereof.

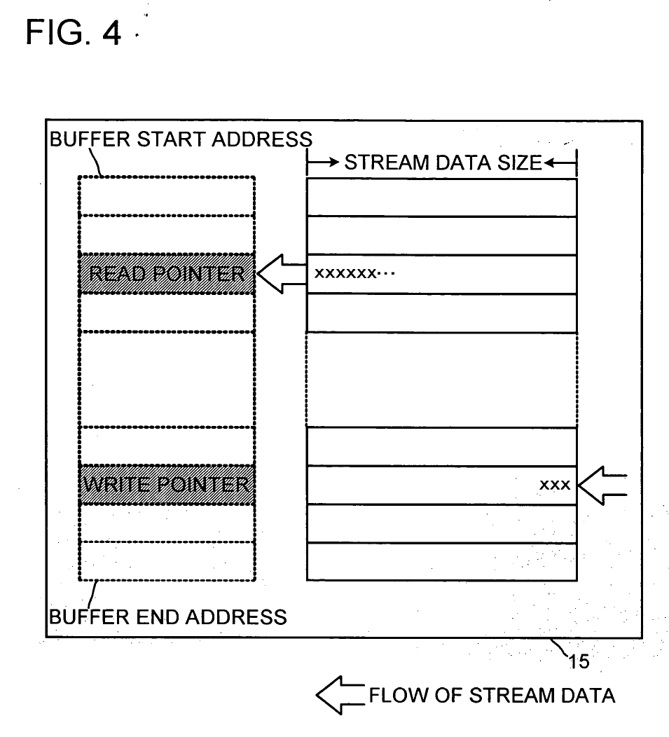

Next, how the buffer amount detecting section 18 acquires the amount of data stored in the buffer 15 will be described. FIG. 4 is a schematic block diagram showing the structure of the data stored in the buffer 15. In the figure, the direction of the flow of the stream data is indicated by arrows.

The buffer 15 is composed of a memory in which stream data is stored piece by piece, and addresses that specify positions within the memory. In FIG. 4, “Read Pointe” indicates the address at which the data reconstructing section 13 reads data, and “Write Pointer” indicates the address at which the data fed from the stream data acquiring section 16 is written.

When a piece of stream data is fed to the buffer from the stream data acquiring section 16, the piece of stream data is written in the memory at the address indicated by “Write Pointer”. On completion of the write, the address indicated by “Write Pointer” is shifted by one. Similarly, the data reconstructing section 13 reads data stored in the memory at the address indicated by “Read Pointer”. On completion of the read, the address indicated by “Read Pointer” is shifted by one. In this way, the position at which data is to be written is specified by the address indicated by “Write Pointer”, and the position from which data is read is specified by the address indicated by “Read Pointer”.

A buffer start address indicates the minimum address, and a buffer end address indicates the maximum address. In the initial state, both “Write Pointer” and “Read Pointer” are placed at the buffer start address. As the stream data is read or written, “Read Pointer” and “Write Pointer” shift accordingly. When either of them reaches the buffer end address, it shifts back to the buffer start address.

In the buffer 15 configured as described above, in the data stored at the address indicated by “Read Pointer” is the oldest at the moment, and in the data stored at the address immediately preceding the address indicated by “Write Pointer” is the newest at the moment. Thus, the data written in the buffer 15 is stored in the area within the memory starting at the address indicated by “Read Pointer” and ending at the address immediately preceding the address indicated by “Write Pointer”. Thus, by calculating the difference between the addresses indicated by “Read Pointer” and “Write Pointer”, it possible to know the amount of data stored in the buffer at the moment.

The buffer amount detecting section 18 reads from the buffer 15 the addresses indicated by “Read Pointer” and “Write Pointer”, and then calculates the difference between them to know the amount of data stored in the buffer. The amount of data stored in the buffer is recognized in this way, and is then compared with the predetermined upper and lower limit values. Then, by adjusting the time intervals of the feeding-out of the stream data as described above, it is possible to keep the amount of data stored in the buffer 15 within the predetermined range.

According to the flowchart shown in FIG. 2, the amount of data stored in the buffer is compared with the lower limit value (step S3), and is then compared with the upper limit value (step S5). This, however, is not meant to limit the order of those comparing steps; the flow may be so modified that the amount of data stored in the buffer is first compared with the upper limit value and then, if it is equal to or less than the upper limit value, with the lower limit value

According to the flowchart shown in FIG. 2, the amount of data stored in the buffer is compared with both the upper and lower limit values; alternatively, it may be compared with only one of the upper and lower limit values. For example, in a case where the amount of data stored in the buffer clearly tends to increase, it may be compared only with the upper limit value; in contrast, in a case where the amount of data stored in the buffer clearly tends to decrease, it may be compared only with the lower limit value.

In a case where a comparison is made only with the upper limit value, if the amount of data stored in the buffer is equal to or more than the upper limit value, the feeding-out intervals may be shortened, and if it is equal to or less than the upper limit value, the feeding-out intervals may be set. at the value set for the normal state. Similarly, in a case where a comparison is made only with the lower limit value, if the amount of data stored in the buffer is equal to or less than the lower limit value, the feeding-out intervals may be lengthened, and if it is equal to or more than the lower limit value, the feeding-out intervals may be set at the value set for the normal state.

The transmitter 3 and the receiver 2 may transmit and receive data by wireless transfer, or may transmit and receive data over a (wired or wireless) network such as LAN or ATM.

A transmitting/receiving system according to the present invention is suitably applied to video on-demand systems and the like that permit, when a transmitter and a receiver are located far apart from each other, people to enjoy video and audio on a television monitor or the like connected to the receiver.

What is claimed is:

1. A receiver comprising:
a receiving section that receives communication data including stream data;
a buffer for temporarily storing the stream data that is acquired from the communication data received in said receiving section;
a data amount detecting section that detects an amount of data stored in said buffer; and
a timing determining section that determines timing with which the data stored in said buffer is read.

2. The receiver of claim 1,
wherein said timing determining section varies timing with which the stream data is read from said buffer according to the amount of data stored in said buffer as detected by said data amount detecting section.

3. The receiver of claim 2,
wherein, when said data amount detecting section detects that the amount of data stored in said buffer is more than a first data amount, said timing determining section shortens time intervals at which the stream data is read from said buffer.

4. The receiver of claim 3,
wherein, when said data amount detecting section detects that the amount of data stored in said buffer is less than a second data amount, said timing determining section lengthens time intervals at which the stream data is read from said buffer.

5. The receiver of claim 2, further comprising:
a clock generating section that generates a clock signal,
wherein said timing determining section varies timing with which the stream data is read from said buffer by use of the clock signal outputted from said clock generating section.

6. The receiver of claim 5,
wherein, when said data amount detecting section detects that the amount of data stored in said buffer is more than a first data amount, said timing determining section shortens time intervals at which the stream data is read from said buffer by a predetermined number of clocks.

7. The receiver of claim 6,
wherein, when said data amount detecting section detects that the amount of data stored in said buffer is less than a second data amount, said timing determining section lengthens time intervals at which the stream data is read from said buffer by a predetermined number of clocks.

8. The receiver of claim 2, wherein said buffer is composed of:
a memory that stores stream data; and
addresses that are serial values indicating positions within said memory, and said data amount detecting section determines the amount of data stored in said buffer by calculating a difference between a first address at which the stream data fed in to said buffer starts to be written thereto and a second address at which the stream data fed out from said buffer starts to be read therefrom.

9. A transmitting/receiving system comprising:
the receiver of claim 1; and
a transmitter that generates stream data including at least a piece of video or audio data, that then converts said stream data into communication data in a transmittable form, and that then transmits the communication data to said receiver.

10. The transmitting/receiving system of claim 9,
wherein said receiver acquires the stream data from the communication data fed from said transmitter, then reconstructs from the stream data the video or audio data, and then feeds the reconstructed video or audio data to a video/audio-outputting section.

11. A communication method comprising:
a first step of receiving communication data including stream data;
a second step of temporarily storing in a buffer the stream data that is acquired from the communication data received in said first step;
a third step of detecting an amount of data stored in said buffer; and
a fourth step of determining timing with which the data stored in said buffer is read according to the amount of data detected in said third step,
wherein said receiver receives the stream data transmitted from said transmitter.

12. The communication method of claim 11,
wherein said fourth step includes a step of, when the amount of data stored in said buffer is detected to be more than a first data amount, shortening time intervals at which the stream data is read from said buffer.

13. The communication method of claim 12,
wherein said fourth step includes a step of, when the amount of data stored in said buffer is detected to be less than a second data amount, lengthening time intervals at which the stream data is read from said buffer.

14. The communication method of claim 11,
wherein said fourth step is a step of varying the timing with which the stream data is read from the buffer by use of a clock signal outputted from a clock generating section.

15. The communication method of claim 14,
wherein said fourth step includes a step of, when the amount of data stored in said buffer is detected to be more than said first data amount, shortening time intervals at which the stream data is read from said buffer by a predetermined number of clocks.

16. The communication method of claim 15,
wherein said fourth step includes a step of, when the amount of data stored in said buffer is detected to be less than said second data amount, lengthening time intervals at which the stream data is read from said buffer by a predetermined number of clocks.

17. The communication method of claim 11, wherein the buffer is composed of:
a memory that stores stream data; and
addresses that are serial values indicating positions within said memory, and said third step is a step of determining the amount of data stored in the buffer by calculating a difference between a first address at which the stream data fed in to the buffer starts to be written thereto and a second address at which the stream data fed out from the buffer starts to be read therefrom.
